(19) United States
(12) Patent Application Publication
(10) Pub. No.: US 2024/0034288 A1
(43) Pub. Date: Feb. 1, 2024

(54) ACCURATE BRAKE HOLDING PRESSURE ON A GRADIENT OF THE AUTONOMOUS DRIVING (AD) VEHICLE CONTROL SYSTEM

(71) Applicant: Baidu USA LLC, Sunnyvale, CA (US)

(72) Inventors: Baoping YUAN, Sunnyvale, CA (US); Tianjia SUN, Sunnyvale, CA (US); Yaoming SHEN, Sunnyvale, CA (US); Shu JIANG, Sunnyvale, CA (US)

(21) Appl. No.: 17/873,645

(22) Filed: Jul. 26, 2022

(51) Int. Cl. B60T 8/172

(52) U.S. Cl. CPC B60T 8/172; B60T 2201/06; B60T 2210/20

(57) ABSTRACT

In an embodiment, an autonomous driving system (ADS) determines that a corresponding autonomous driving vehicle (ADV) has stopped on a gradient. The ADS determines a first brake hold pressure based on a first gradient value of the ADV measured at a first point in time. The ADS then applies the first brake hold pressure to a brake system in the ADV. Then, the ADS determines a second brake hold pressure based on a second gradient value of the ADV measured at a second point in time. The ADS then applies the second brake hold pressure to the brake system accordingly.

### TECHNICAL FIELD

Embodiments of the present disclosure relate generally to operating autonomous driving vehicles. More particularly, embodiments of the disclosure relate to applying an accurate brake holding pressure to the autonomous driving vehicle when the autonomous driving vehicle is stopped on a gradient.

### BACKGROUND

Vehicles operating in an autonomous mode (e.g., driverless) can relieve occupants, especially the driver, from some driving-related responsibilities. When operating in an autonomous mode, the vehicle can navigate to various locations using onboard sensors, allowing the vehicle to travel with minimal human interaction or in some cases without any passengers.

Brake control is a critical operation in autonomous driving. A brake hold pressure should be adaptable to different gradients (e.g., slope) when the autonomous driving vehicle is stopped on a slope for a short time or an extended time. If the brake hold pressure is too low, the vehicle will slip (move) after stopping. If the brake hold pressure is too high, the brake system consumes an unwarranted amount of current; the vehicle is difficult to release; and the brake system produces unwanted noise while being held and during release. In addition, extensive brake hold pressure fluctuations while being held lead to noise, vibration, and harshness (NVH) issues on the autonomous driving vehicle.

### BRIEF DESCRIPTION OF THE DRAWINGS

Embodiments of the disclosure are illustrated by way of example and not limitation in the figures of the accompanying drawings in which like references indicate similar elements.

FIG. 1 is a block diagram illustrating a networked system according to one embodiment.

FIG. 2 is a block diagram illustrating an example of an autonomous driving vehicle according to one embodiment.

FIGS. 3A-3B are block diagrams illustrating an example of an autonomous driving system used with an autonomous driving vehicle according to one embodiment.

FIG. 4 is a block diagram illustrating an example of a brake intention module according to one embodiment.

FIGS. 5A and 5B are block diagrams illustrating examples of various brake systems according to some embodiments.

FIG. 6 is a diagram illustrating an example of different phases of an ADV stopping on a gradient.

FIGS. 7 through 9 are diagrams illustrating examples of an autonomous driving system applying an accurate brake holding pressure to an autonomous driving vehicle stopped on a gradient.

FIGS. 10A and 10B are diagrams illustrating an example of computing lower and upper brake holding threshold values.

FIG. 11 is a flow diagram illustrating a method to apply an accurate brake holding pressure to an autonomous driving vehicle stopped on a gradient according to one embodiment.

### DETAILED DESCRIPTION

Various embodiments and aspects of the disclosures will be described with reference to the details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to one embodiments, an autonomous driving system (ADS) determines that a corresponding autonomous driving vehicle (ADV) has stopped on a gradient. The ADS determines a first brake hold pressure based on a first gradient value of the ADV measured at a first point in time. The ADS then applies the first brake hold pressure to a brake system in the ADV. Responsive to applying the first brake hold pressure to the brake system, the ADS determines a second brake hold pressure based on a second gradient value of the ADV measured at a second point in time. The ADS then applies the second brake hold pressure to the brake system.

In one embodiment, the ADS determines a third brake hold pressure based on a third gradient value of the ADV measured at a third point in time. The ADS then applies the third brake hold pressure to the brake system.

In another embodiment, the ADS determines a first brake threshold range based on the first gradient value, wherein the first brake hold pressure is based on the first brake threshold range. The ADS determines a second brake threshold range based on the second gradient value. Then, in response to determining that the first brake hold pressure is within the second brake threshold range, the ADS maintains the second brake hold pressure the same as the first brake hold pressure. However, in response to determining that the first brake hold pressure is outside the second brake threshold range, the ADS sets the second brake hold pressure to be within the second brake threshold range.

In another embodiment, the second brake hold pressure is higher than the first brake hold pressure. In another embodiment, the second brake hold pressure is lower than the first brake hold pressure and the second brake hold pressure reduces an amount of current required to maintain the ADV at a stopped stated on the gradient.

In another embodiment, the ADV generates a processed gradient value for determining the first gradient value and the second gradient value.

In another embodiment, prior to the first point in time, the ADS computes an initial gradient value of the ADV based on a peak value of the processed gradient value and a trough value of the processed gradient value. The ADS then determines the first brake hold pressure based on the initial gradient value.

In another embodiment, the first brake hold pressure and the second brake hold pressure are based on a weight of the ADV. In another embodiment, the gradient is a descending gradient.

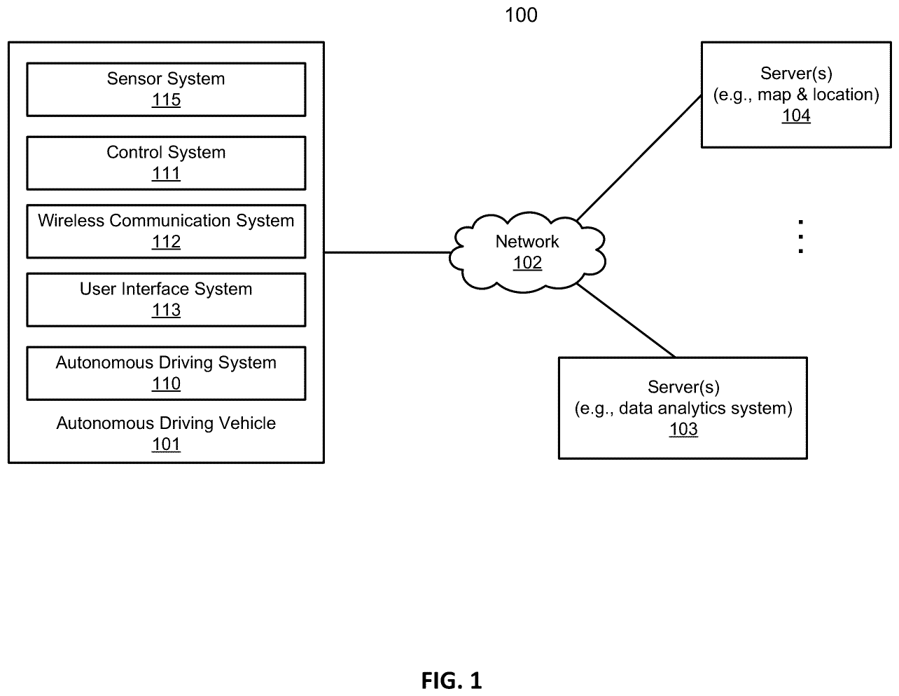

FIG. 1 is a block diagram illustrating an autonomous driving network configuration according to one embodiment of the disclosure. Referring to FIG. 1, network configuration 100 includes autonomous driving vehicle (ADV) 101 that may be communicatively coupled to one or more servers 103-104 over a network 102. Although there is one ADV shown, multiple ADVs can be coupled to each other and/or coupled to servers 103-104 over network 102. Network 102 may be any type of networks such as a local area network (LAN), a wide area network (WAN) such as the Internet, a cellular network, a satellite network, or a combination thereof, wired or wireless. Server(s) 103-104 may be any kind of servers or a cluster of servers, such as Web or cloud servers, application servers, backend servers, or a combination thereof. Servers 103-104 may be data analytics servers, content servers, traffic information servers, map and point of interest (MPOI) servers, or location servers, etc.

An ADV refers to a vehicle that can be configured to in an autonomous mode in which the vehicle navigates through an environment with little or no input from a driver. Such an ADV can include a sensor system having one or more sensors that are configured to detect information about the environment in which the vehicle operates. The vehicle and its associated controller(s) use the detected information to navigate through the environment. ADV 101 can operate in a manual mode, a full autonomous mode, or a partial autonomous mode.

In one embodiment, ADV 101 includes, but is not limited to, autonomous driving system (ADS) 110, vehicle control system 111, wireless communication system 112, user interface system 113, and sensor system 115. ADV 101 may further include certain common components included in ordinary vehicles, such as, an engine, wheels, steering wheel, transmission, etc., which may be controlled by vehicle control system 111 and/or ADS 110 using a variety of communication signals and/or commands, such as, for example, acceleration signals or commands, deceleration signals or commands, steering signals or commands, braking signals or commands, etc.

Components 110-115 may be communicatively coupled to each other via an interconnect, a bus, a network, or a combination thereof. For example, components 110-115 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

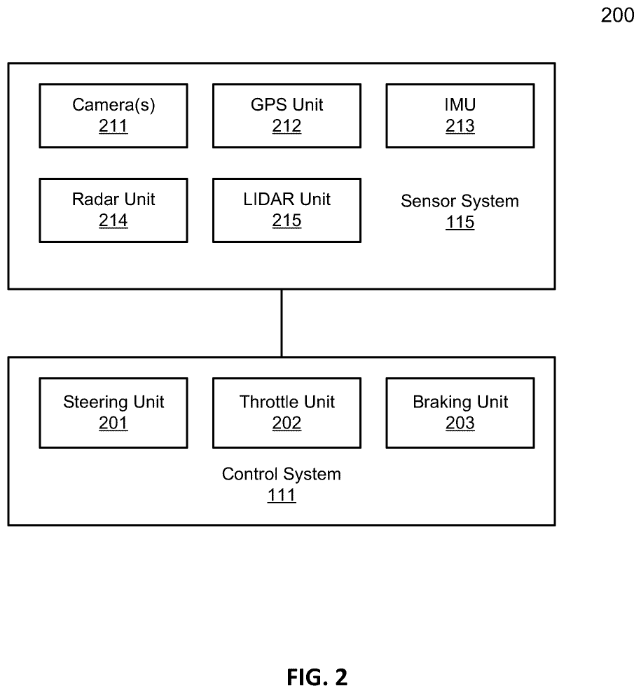

Referring now to FIG. 2, in one embodiment, sensor system 115 includes, but it is not limited to, one or more cameras 211, global positioning system (GPS) unit 212, inertial measurement unit (IMU) 213, radar unit 214, and a light detection and range (LIDAR) unit 215. GPS system 212 may include a transceiver operable to provide information regarding the position of the ADV. IMU unit 213 may sense position and orientation changes of the ADV based on inertial acceleration. Radar unit 214 may represent a system that utilizes radio signals to sense objects within the local environment of the ADV. In some embodiments, in addition to sensing objects, radar unit 214 may additionally sense the speed and/or heading of the objects. LIDAR unit 215 may sense objects in the environment in which the ADV is located using lasers. LIDAR unit 215 could include one or more laser sources, a laser scanner, and one or more detectors, among other system components. Cameras 211 may include one or more devices to capture images of the environment surrounding the ADV. Cameras 211 may be still cameras and/or video cameras. A camera may be mechanically movable, for example, by mounting the camera on a rotating and/or tilting a platform.

Sensor system 115 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the ADV. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 111 includes, but is not limited to, steering unit 201, throttle unit 202 (also referred to as an acceleration unit), and braking unit 203. Steering unit 201 is to adjust the direction or heading of the vehicle. Throttle unit 202 is to control the speed of the motor or engine that in turn controls the speed and acceleration of the vehicle. Braking unit 203 is to decelerate the vehicle by providing friction to slow the wheels or tires of the vehicle. Note that the components as shown in FIG. 2 may be implemented in hardware, software, or a combination thereof.

Referring back to FIG. 1, wireless communication system 112 is to allow communication between ADV 101 and external systems, such as devices, sensors, other vehicles, etc. For example, wireless communication system 112 can wirelessly communicate with one or more devices directly or via a communication network, such as servers 103-104 over network 102. Wireless communication system 112 can use any cellular communication network or a wireless local area network (WLAN), e.g., using WiFi to communicate with another component or system. Wireless communication system 112 could communicate directly with a device (e.g., a mobile device of a passenger, a display device, a speaker within vehicle 101), for example, using an infrared link, Bluetooth, etc. User interface system 113 may be part of peripheral devices implemented within vehicle 101 including, for example, a keyboard, a touch screen display device, a microphone, and a speaker, etc.

Some or all of the functions of ADV 101 may be controlled or managed by ADS 110, especially when operating in an autonomous driving mode. ADS 110 includes the necessary hardware (e.g., processor(s), memory, storage) and software (e.g., operating system, planning and routing programs) to receive information from sensor system 115, control system 111, wireless communication system 112, and/or user interface system 113, process the received information, plan a route or path from a starting point to a destination point, and then drive vehicle 101 based on the planning and control information. Alternatively, ADS 110 may be integrated with vehicle control system 111.

For example, a user as a passenger may specify a starting location and a destination of a trip, for example, via a user interface. ADS 110 obtains the trip related data. For example, ADS 110 may obtain location and route data from an MPOI server, which may be a part of servers 103-104. The location server provides location services and the MPOI server provides map services and the POIs of certain locations. Alternatively, such location and MPOI information may be cached locally in a persistent storage device of ADS 110.

While ADV 101 is moving along the route, ADS 110 may also obtain real-time traffic information from a traffic information system or server (TIS). Note that servers 103-104 may be operated by a third party entity. Alternatively, the functionalities of servers 103-104 may be integrated with ADS 110. Based on the real-time traffic information, MPOI information, and location information, as well as real-time local environment data detected or sensed by sensor system 115 (e.g., obstacles, objects, nearby vehicles), ADS 110 can plan an optimal route and drive vehicle 101, for example, via control system 111, according to the planned route to reach the specified destination safely and efficiently.

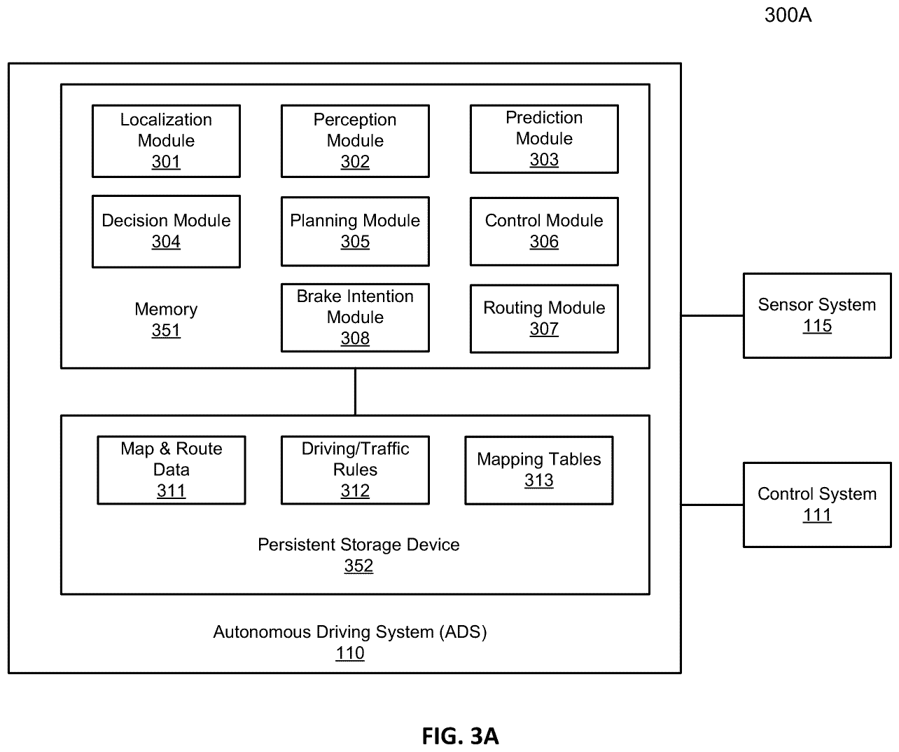

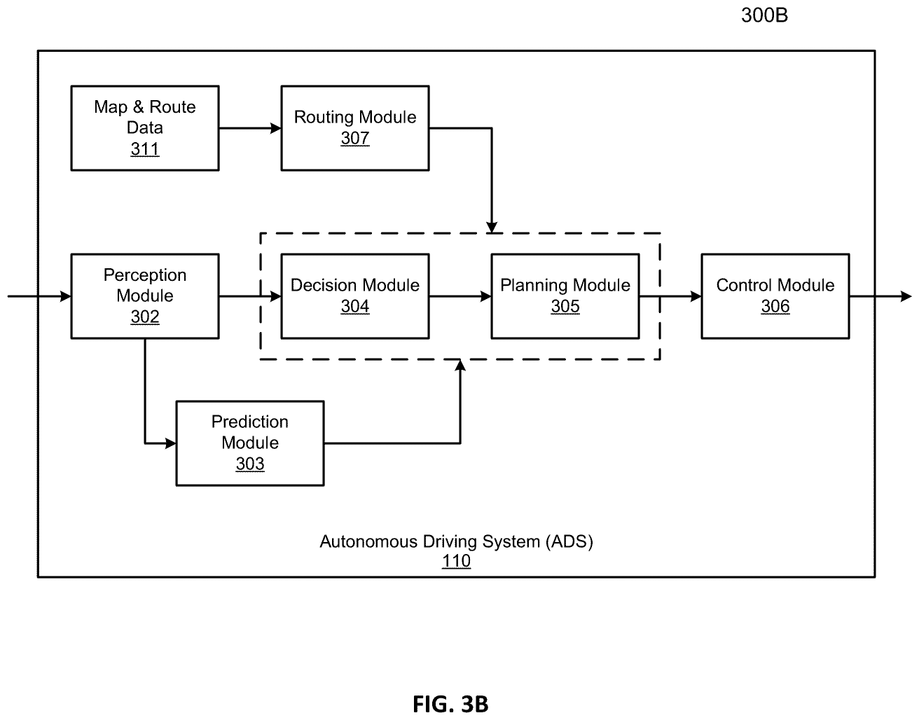

FIGS. 3A and 3B are block diagrams illustrating an example of an autonomous driving system used with an ADV according to one embodiment. System 300 may be implemented as a part of ADV 101 of FIG. 1 including, but is not limited to, ADS 110, control system 111, and sensor system 115. Referring to FIGS. 3A-3B, ADS 110 includes, but is not limited to, localization module 301, perception module 302, prediction module 303, decision module 304, planning module 305, control module 306, routing module 307, and brake intention module.

Some or all of modules 301-308 may be implemented in software, hardware, or a combination thereof. For example, these modules may be installed in persistent storage device 352, loaded into memory 351, and executed by one or more processors (not shown). Note that some or all of these modules may be communicatively coupled to or integrated with some or all modules of vehicle control system 111 of FIG. 2. Some of modules 301-308 may be integrated together as an integrated module.

Localization module 301 determines a current location of ADV 300 (e.g., leveraging GPS unit 212) and manages any data related to a trip or route of a user. Localization module 301 (also referred to as a map and route module) manages any data related to a trip or route of a user. A user may log in and specify a starting location and a destination of a trip, for example, via a user interface. Localization module 301 communicates with other components of ADV 300, such as map and route data 311, to obtain the trip related data. For example, localization module 301 may obtain location and route data from a location server and a map and POI (MPOI) server. A location server provides location services and an MPOI server provides map services and the POIs of certain locations, which may be cached as part of map and route data 311. While ADV 300 is moving along the route, localization module 301 may also obtain real-time traffic information from a traffic information system or server.

Based on the sensor data provided by sensor system 115 and localization information obtained by localization module 301, a perception of the surrounding environment is determined by perception module 302. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 302 may include a computer vision system or functionalities of a computer vision system to process and analyze images captured by one or more cameras in order to identify objects and/or features in the environment of the ADV. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 302 can also detect objects based on other sensors data provided by other sensors such as a radar and/or LIDAR.

For each of the objects, prediction module 303 predicts what the object will behave under the circumstances. The prediction is performed based on the perception data perceiving the driving environment at the point in time in view of a set of map/route information 311 and traffic rules 312. For example, if the object is a vehicle at an opposing direction and the current driving environment includes an intersection, prediction module 303 will predict whether the vehicle will likely move straight forward or make a turn. If the perception data indicates that the intersection has no traffic light, prediction module 303 may predict that the vehicle may have to fully stop prior to enter the intersection. If the perception data indicates that the vehicle is currently at a left-turn only lane or a right-turn only lane, prediction module 303 may predict that the vehicle will more likely make a left turn or right turn respectively.

For each of the objects, decision module 304 makes a decision regarding how to handle the object. For example, for a particular object (e.g., another vehicle in a crossing route) as well as its metadata describing the object (e.g., a speed, direction, turning angle), decision module 304 decides how to encounter the object (e.g., overtake, yield, stop, pass). Decision module 304 may make such decisions according to a set of rules such as traffic rules or driving rules 312, which may be stored in persistent storage device 352.

Routing module 307 is configured to provide one or more routes or paths from a starting point to a destination point. For a given trip from a start location to a destination location, for example, received from a user, routing module 307 obtains route and map information 311 and determines all possible routes or paths from the starting location to reach the destination location. Routing module 307 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line. The topographic maps are then provided to decision module 304 and/or planning module 305. Decision module 304 and/or planning module 305 examine all of the possible routes to select and modify one of the most optimal routes in view of other data provided by other modules such as traffic conditions from localization module 301, driving environment perceived by perception module 302, and traffic condition predicted by prediction module 303. The actual path or route for controlling the ADV may be close to or different from the reference line provided by routing module 307 dependent upon the specific driving environment at the point in time.

Based on a decision for each of the objects perceived, planning module 305 plans a path or route for the ADV, as well as driving parameters (e.g., distance, speed, and/or turning angle), using a reference line provided by routing module 307 as a basis. That is, for a given object, decision module 304 decides what to do with the object, while planning module 305 determines how to do it. For example, for a given object, decision module 304 may decide to pass the object, while planning module 305 may determine whether to pass on the left side or right side of the object. Planning and control data is generated by planning module 305 including information describing how vehicle 101 would move in a next moving cycle (e.g., next route/path segment). For example, the planning and control data may instruct vehicle 101 to move 10 meters at a speed of 30 miles per hour (mph), then change to a right lane at the speed of 25 mph.

Based on the planning and control data, control module 306 controls and drives the ADV, by sending proper commands or signals to vehicle control system 111, according to a route or path defined by the planning and control data. The planning and control data include sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 305 plans a next route segment or path segment, for example, including a target position and the time required for the ADV to reach the target position. Alternatively, planning module 305 may further specify the specific speed, direction, and/or steering angle, etc. In one embodiment, planning module 305 plans a route segment or path segment for the next predetermined period of time such as 5 seconds. For each planning cycle, planning module 305 plans a target position for the current cycle (e.g., next 5 seconds) based on a target position planned in a previous cycle. Control module 306 then generates one or more control commands (e.g., throttle, brake, steering control commands) based on the planning and control data of the current cycle.

Note that decision module 304 and planning module 305 may be integrated as an integrated module. Decision module 304/planning module 305 may include a navigation system or functionalities of a navigation system to determine a driving path for the ADV. For example, the navigation system may determine a series of speeds and directional headings to affect movement of the ADV along a path that substantially avoids perceived obstacles while generally advancing the ADV along a roadway-based path leading to an ultimate destination. The destination may be set according to user inputs via user interface system 113. The navigation system may update the driving path dynamically while the ADV is in operation. The navigation system can incorporate data from a GPS system and one or more maps so as to determine the driving path for the ADV.

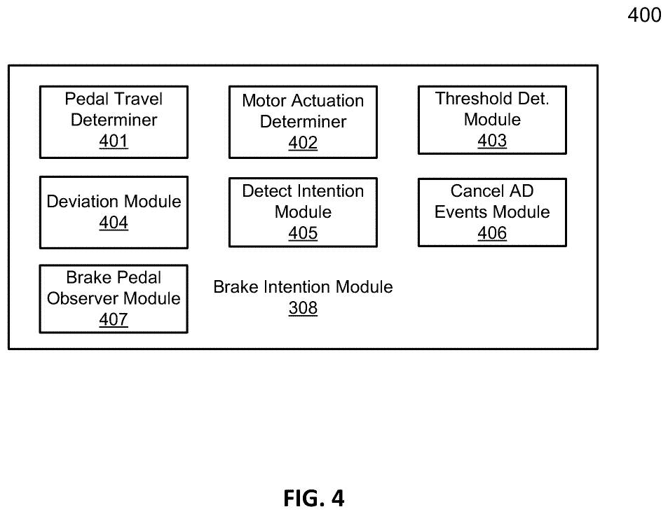

FIG. 4 is a block diagram illustrating an example of a brake intention module 308 according to one embodiment. Brake intention module 308 can detect an operator intention to apply a brake control. In one embodiment, brake intention module 308 can include pedal travel determiner module 401, motor actuation determiner module 402, threshold determiner module 403, deviation module 404, detect intention module 405, cancel AD events module 406, and brake pedal observer module 407. Pedal travel determiner module 401 can determine and observe a pedal travel distance sensor value by obtaining a measurement reading from a brake pedal travel sensor of a brake booster. Motor actuation determiner module 402 can determine a motor actuation position of a motor in the brake booster that electronically controls the brake pedal travel distance from a motor actuation sensor. Threshold determiner module 403 can use the measured motor actuation position to obtain a mapping value from a mapping table, such as mapping tables 313 of FIG. 3A, and calculate a threshold value. The threshold value can correspond to a threshold value that the pedal travel distance sensor value needs to exceed to register an operator intervention or a threshold value that a difference of the pedal travel distance sensor value and actuation position need to exceed to register an operator intervention. Deviation module 404 can determine a deviation value for any of the brake pedal travel sensor, actuation position, and threshold. Detect intention module 405 can detect an operator intervention using the deviation value. Cancel AD events module 406 can cancel the AD events that are issued or pending issuance to the ADV. Here, the AD events can include acceleration request, driving steering request, a signal request, a deceleration request, etc. Brake pedal observer module 407 can determine an observed brake pedal travel value.

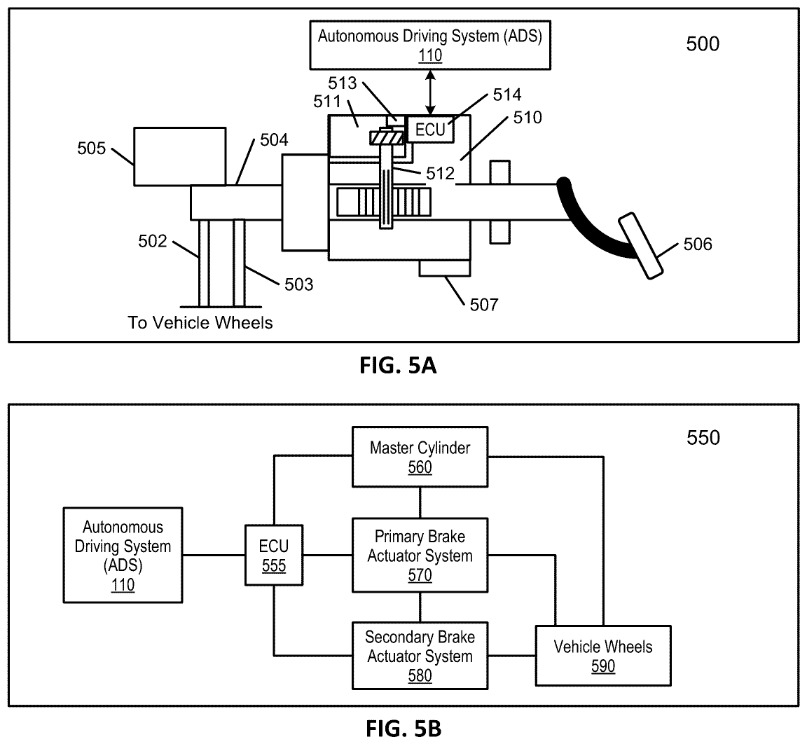

FIG. 5A shows a representation of a hydraulic brake system 500 for a vehicle. Vehicle brake system 500 can include a front axle brake circuit 502 and a rear axle brake circuit 503 for actuating wheel brake devices (not shown) for the wheels of the ADV using a brake fluid that is under hydraulic pressure. Brake circuits 502 and 503 can be connected to master brake cylinder 504 that is supplied with the brake fluid by a brake fluid reservoir container 505. A master brake cylinder piston within master brake cylinder 504 is operable via brake pedal 506.

In one embodiment, brake system 500 includes a braking force booster 510 that is coupled between brake pedal 506 and master brake cylinder 5044. Booster 410 can include an electric motor 411, mechanical gearbox 412, and an electronic control unit (ECU) 414. ECU 414 can present a microcontroller that controls the actuations of booster 410. Booster 510 can boost a brake control that is applied by an operator. For example, a brake pedal travel distance that is exerted by an operator can be measured by pedal travel sensor 507. A signal of pedal travel sensor 507 can be transmitted from ADS 110 to ECU 514 of booster 510 to cause gears of mechanical gearbox 512 to rotate thereby boosting the applied brake pedal and causing the hydraulic brake pressure at master brake cylinder 504 to increase. In one embodiment, the actuation position of electric motor 511 can be measured by an actuation sensor 513.

Brake fluid can be carried in each brake circuit 502 and 503, and are supplied to brake devices (not shown) of the vehicle wheels. The brake hydraulics can further include a hydraulic pump (not shown) to control the hydraulic brake pressure of the brake hydraulics.

For an autonomous driving mode, an ADS can request brake controls (e.g., a pedal travel distance) by sending a signal from ADS 110 to ECU 514 of booster 510 to cause gears of the mechanical gearbox 512 to rotate and to actuate the piston of the master brake cylinder 504. Furthermore, a brake control system can obtain sensors values from ECU 514 of booster 510 to obtain measurements of travel sensor 507 and/or actuation sensor 513.

As discussed herein, ADS 110 provides information to ECU 514 to apply accurate brake hold pressure while ADV 101 is stopped on a gradient. Referring to FIG. 3B, planning module 305, control module 306, and/or other modules shown in 300B may perform the computations, determinations, and steps required to instruct ECU 514 of the accurate brake hold pressure.

Although the vehicle brake hydraulics system is described with brake fluid hydraulics, the embodiments are not limited to fluid hydraulic brakes. For example, an electronic brake system can be used instead of the fluid hydraulics brake system.

FIG. 5B is a diagram illustrating an example of a redundant Drive-By-Wire (DBW) brake system for a vehicle. In one embodiment, DBW technology in automotive vehicles replaces traditional mechanical and hydraulic systems with mechatronic actuation and control.

Brake system 550 includes master cylinder 550 that couples to primary brake actuator system 570. Similar to that discussed above, ADS 110 provides information to ECU 555 to apply accurate brake hold pressure while ADV 101 is stopped on a gradient. Primary brake actuator system 570 includes a travel sensor, motor sensor, and motor. Primary brake actuator system 570 couples to secondary brake actuator system 580. Secondary brake actuator system 580 receives brake hold pressure information from primary brake actuator system 570 and applies an appropriate braking force to vehicle wheels 590 accordingly.

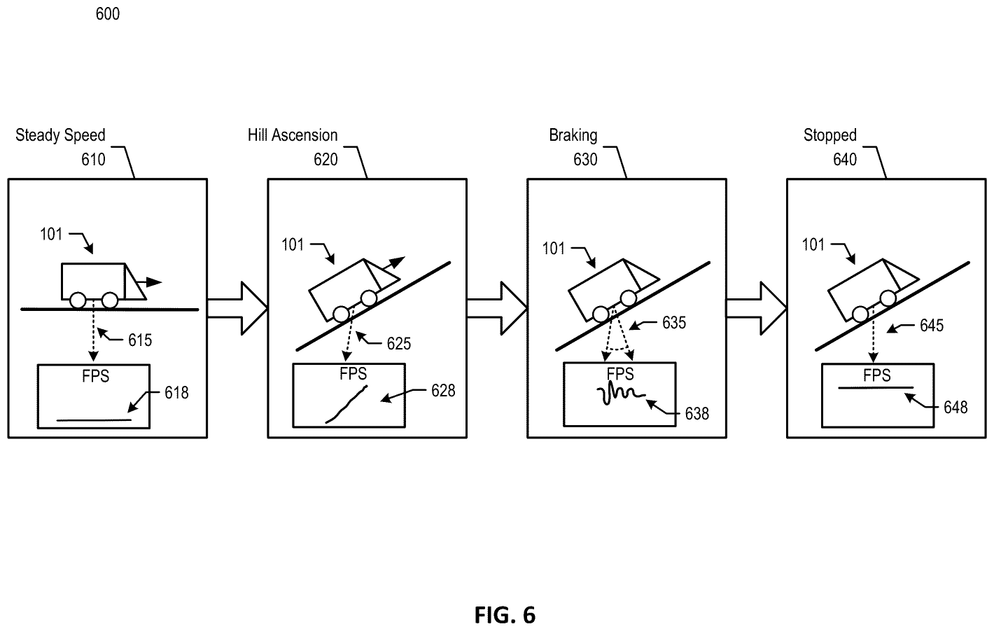

FIG. 6 is a diagram illustrating an example of different phases of an ADV stopping on a gradient. Steady speed phase 610 is associated with a consistent speed of ADV 101. During this phase, a processed gradient value within the vehicle is not significantly moving (615) in a horizontal direction because ADV 101 is not accelerating or decelerating. As such, the horizontal value (x direction) of the processed gradient value (PGV) 618 is at a constant value. In one embodiment, the processed gradient value is calculated from IMU sensors (IMU 213) and/or Ax sensor, or by a filter, such as a Kalman filter.

At hill ascension phase 620, ADV 101 is ascending on a gradient and the processed gradient value moves within ADV 101 to stabilize. In other words, processed gradient value 628 indicates a gradient value of the gradient (the amount of incline or decline of the gradient).

ADV 101 begins to brake at braking phase 630. At this phase, the processed gradient value 635 fluctuates back and forth to find a steady state. This causes processed gradient value 638 to fluctuate. As such, attempting to determine a gradient value of the gradient during the braking phase is ineffective due to the changing processed gradient value values.

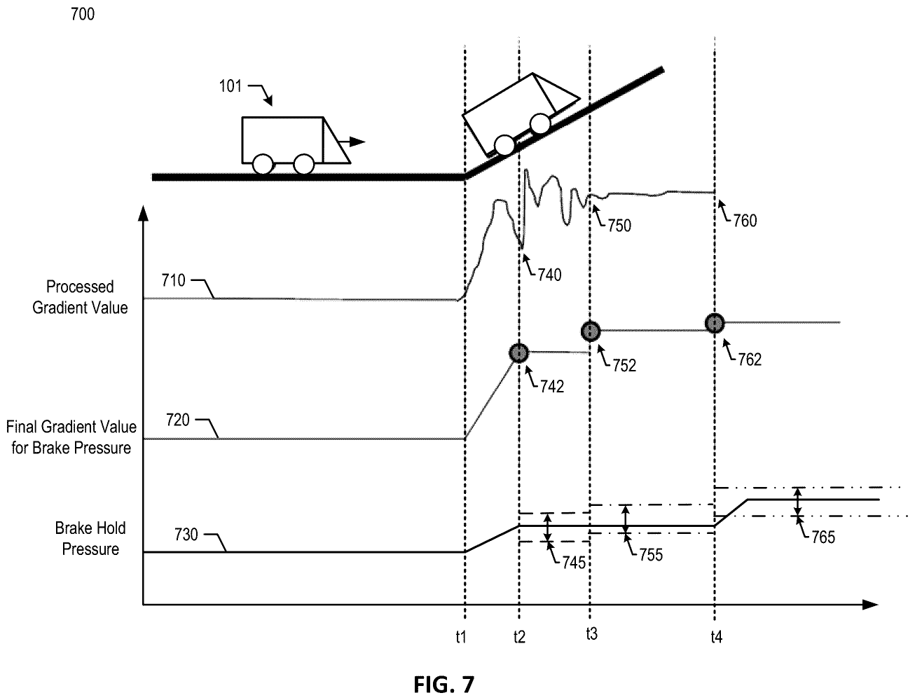

At stopped phase 640, ADV 101 has stopped and the processed gradient value stops moving and processed gradient value 648 is at a steady value. Processed gradient value 648 is higher than processed gradient value 618, indicating that the gradient at stopped phase 640 has an increased gradient value (increased slope) compared with steady speed phage 610. FIGS. 7 through 9 shows various embodiments that combine the four phases shown in FIG. 6 for applying an accurate brake holding pressure on ADV 101.

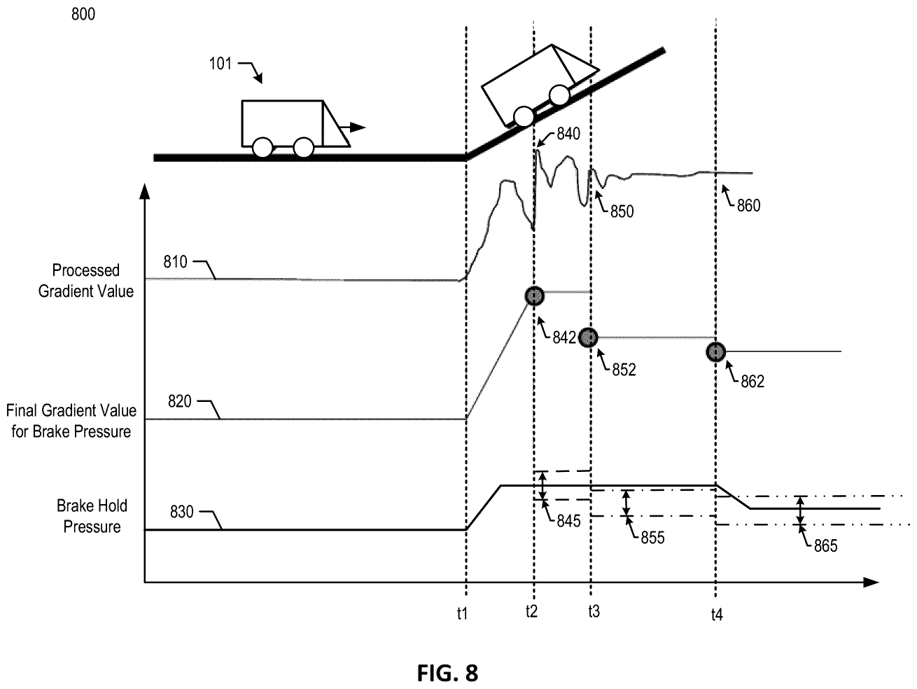

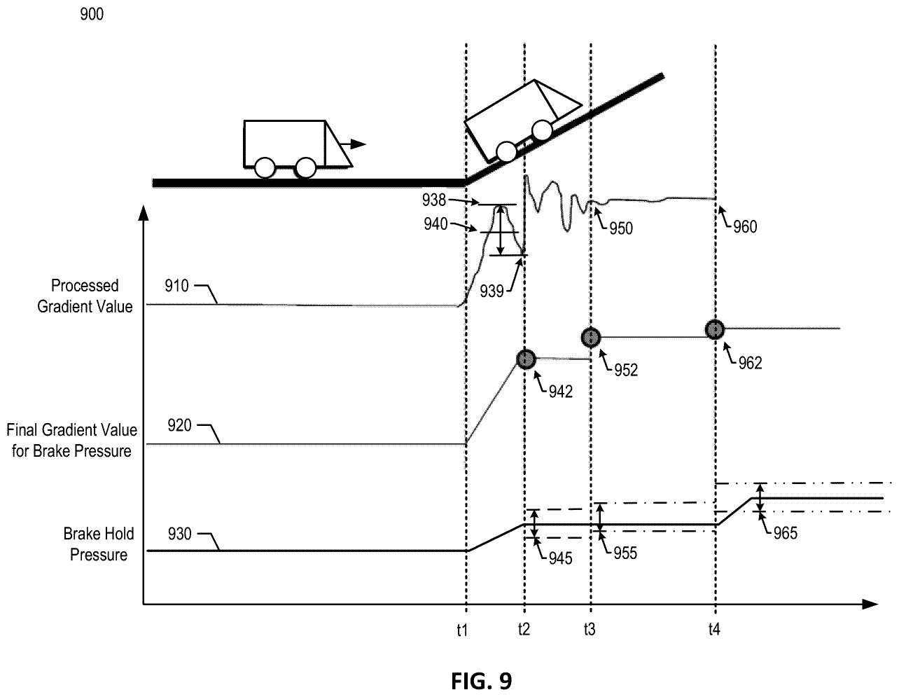

FIG. 7 is a diagram illustrating an example of an autonomous driving system (ADS 110) in ADV 101 applying an accurate brake holding pressure on a gradient. FIGS. 7 through 9 depict various embodiments of applying an accurate brake holding pressure on a gradient. The example in FIG. 7 shows that the final brake holding pressure increases from the initial brake holding pressure. The example in FIG. 8 shows that the final brake holding pressure decreases from the initial brake holding pressure. And, the example in FIG. 9 shows ADS 110 performing pre-processing computations to better determine the initial brake holding pressure.

Referring back to FIG. 7, prior to time t1, ADV 101 is traveling at a consistent speed on a horizontal surface. During this time, processed gradient value 710, final gradient value for brake pressure 720, and brake hold pressure 730 remain unchanged. In one embodiment, as discussed above, the processed gradient value is calculated from IMU sensors (IMU 213) and/or Ax sensor, or by a filter, such as a Kalman filter.

At time t1, ADV 101 begins to ascent up a gradient, which moves the onboard processed gradient value 710. The example in FIG. 7 also shows that ADV 101 is beginning to brake at time t1 based on the increase in brake hold pressure 730. At time t2, ADS 110 measures processed gradient value 710 and determines a gradient value 742 based on processed gradient value 710's value at time t2 (740). In one embodiment, ADS 110 determines the gradient value 742 approximately 300 milliseconds (ms) after determining no wheel movement on ADV 101.

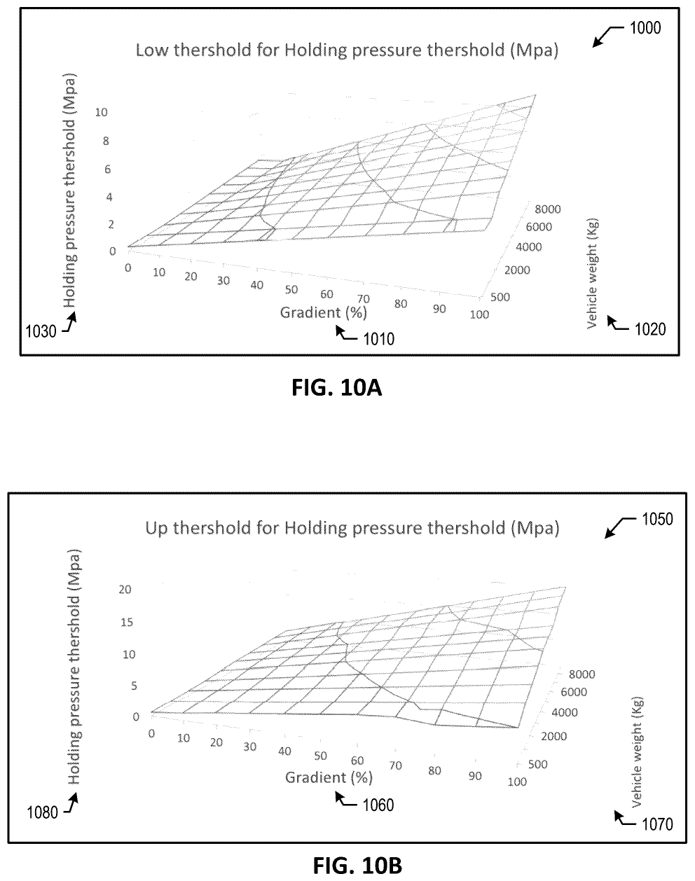

Then, ADS 110 determines brake threshold range 745 based on gradient value 740 using, for example a look-up table and/or formula. In one embodiment, ADS 110 determines the brake threshold range based on the gradient value and the weight of ADV 101. Referring to FIG. 10A, the lower holding pressure threshold (1030) is based on gradient value 1010 and vehicle weight 1020, which in one embodiment is the total vehicle weight including passengers and cargo. Referring to FIG. 10B, the upper holding pressure threshold (1080) is based on gradient value 1060 (same as gradient value 1010) and vehicle weight 1070 (including passengers and cargo).

In turn, in one embodiment, ADS 110 then sets brake hold pressure 730 to be in the middle of brake threshold range 745 at time t2.

Between time t2 and t3, processed gradient value 710 fluctuates due to ADV 101 stopping. At time t3, ADS 110 measures processed gradient value 710 and determines gradient value 752 based on processed gradient value 710's value at time t3 (750). In one embodiment, ADS 110 determines gradient value 752 approximately 700 ms (range: 0-10 seconds) after determining gradient value 742, which can be set/calculated based on the amplitude and frequency of pitching. ADS 110 then determines brake threshold range 755 based on gradient value 752 and, in one embodiment, the weight of ADV 101. The example in FIG. 7 shows that brake threshold range 755 is higher than brake threshold range 745 because gradient value 752 is higher than gradient value 742. At this point, ADS 110 does not adjust brake hold pressure 730 because brake hold pressure 730 is still within brake threshold range 755.

At time t4, ADS 110 measures processed gradient value 710 and determines a gradient value 762 based on processed gradient value 710's value at time t4 (760). ADS 110 then determines brake threshold range 765 based on the gradient value 762. The example in FIG. 7 shows that brake threshold range 765 is higher than brake threshold range 755 because gradient value 762 is higher than gradient value 752. At this point, ADS 110 increases the brake hold pressure 730 to the middle of brake threshold range 765. This value is the accurate brake pressure value to keep ADV 101 stopped while also minimizing the amount of current required for the brake system.

FIG. 8 is a diagram illustrating another example of an autonomous driving system (ADS 110) in ADV 101 applying an accurate brake holding pressure on a gradient. As discussed earlier, the example in FIG. 8 compared with FIG. 7 shows that the final brake holding pressure decreases from the initial brake holding pressure.

Prior to time t1, ADV 101 is traveling at a consistent speed on a horizontal surface. During this time, processed gradient value 810, final gradient value for brake pressure 820, and brake hold pressure 830 remain unchanged.

At time t1, ADV 101 begins to ascent up a gradient, which moves the onboard processed gradient value 810. The example in FIG. 8 also shows that ADV 101 is beginning to brake at time t1 based on the increase in brake hold pressure 830. At time t2, ADS 110 measures processed gradient value 810 and determines a gradient value 842 based on processed gradient value 810's value at time t2 (840). Comparing the example in FIG. 8 with the example in FIG. 7, gradient value 842 is higher than gradient value 742 because the processed gradient value 810 measurement in FIG. 8 was taken when the signal was spiking (840) compared to the processed gradient value 710 measurement in FIG. 7 being taken when the signal was in a trough (740). Referring back to FIG. 8, ADS 110 then determines brake threshold range 845 based on gradient value 840 (and the weight of ADV 101), and then sets brake hold pressure 830 to be in the middle of brake threshold range 845 at time t2.

Between time t2 and t3, processed gradient value 810 fluctuates due to ADV 101 stopping. At time t3, ADS 110 measures processed gradient value 810 and determines gradient value 852 based on processed gradient value 810's value at time t3 (850). In one embodiment, ADS 110 determines gradient value 852 approximately, for example, 700 ms (range: 0-10 seconds) after determining gradient value 842, which can be set/calculated based on the amplitude and frequency of pitching. ADS 110 then determines brake threshold range 855 based on gradient value 852. The example in FIG. 8 shows that brake threshold range 855 is higher than brake threshold range 845 because gradient value 852 is higher than gradient value 842. In one embodiment, as shown in FIG. 8, when the existing brake hold pressure is higher than a new max holding pressure, ADS 110 may not decrease pressure at this point because ADV 100 may still be pitching and to avoid noise.

At time t4, ADS 110 measures processed gradient value 810 and determines a gradient value 862 based on processed gradient value 810's value at time t4 (860). ADS 110 then determines brake threshold range 865 based on the gradient value 862. The example in FIG. 8 shows that brake threshold range 865 is lower than brake threshold range 855 because gradient value 862 is lower than gradient value 852. At this point, ADS 110 decreases the brake hold pressure 830 to the middle of brake threshold range 865, which decreases the current (power) requirement while keeping ADV 101 stopped on the gradient.

FIG. 9 is a diagram illustrating another example of an autonomous driving system (ADS 110) in ADV 101 applying an accurate brake holding pressure on a gradient. As discussed earlier, the example in FIG. 9 shows that the initial gradient value is pre-processed by detecting processed gradient value 910's wave peak value and trough value.

Prior to time t1, ADV 101 is traveling at a consistent speed on a horizontal surface. During this time, processed gradient value 910, final gradient value for brake pressure 920, and brake hold pressure 930 remain unchanged.

At time t1, ADV 101 begins to ascent up a gradient, which moves the onboard processed gradient value 910. At this point, in one embodiment, ADS 110 tracks processed gradient value 910 and determines its peak (938) and trough (939) between time t1 and time t2. ADS 110 then performs pre-processing computations using the peak and trough values to determine computed value 940, which may be the average of values 938 and 939 or a special percentage of values 938 and 939. Then, at time t2, ADS 110 determines a gradient value 942 based on computed processed gradient value 940. ADS 110 then determines brake threshold range 945 based on gradient value 942 and sets brake hold pressure 930 to be in the middle of brake threshold range 945 at time t2.

Between time t2 and t3, processed gradient value 910 fluctuates due to ADV 101 stopping. At time t3, ADS 110 measures processed gradient value 910 and determines gradient value 952 based on processed gradient value 910's value at time t3 (950). In one embodiment, ADS 110 determines gradient value 952 approximately 700 ms (range: 0-10 seconds) after determining gradient value 942, which can be set/calculated based on the amplitude and frequency of pitching. ADS 110 then determines brake threshold range 955 based on gradient value 952 and does not adjust brake hold pressure 930 because brake hold pressure 930 is still within brake threshold range 955.

At time t4, ADS 110 measures processed gradient value 910 and determines a gradient value 962 based on processed gradient value 910's value at time t4 (960). ADS 110 then determines brake threshold range 965 based on the gradient value 962. The example in FIG. 9 shows that brake threshold range 965 is higher than brake threshold range 955 because gradient value 962 is higher than gradient value 952. At this point, ADS 110 increases the brake hold pressure 930 to the middle of brake threshold range 965. This value is the accurate brake pressure value to keep ADV 101 stopped while also minimizing the amount of current required for the brake system.

FIGS. 10A and 10B are diagrams illustrating an example of computing lower and upper brake holding threshold values. Graphs 1000 and 1050 may be generated from lookup tables, for example. These lookup tables may be calibrated in real-time based on ADV 101's braking history on a gradient. For example, ADS 110 may determine that the final brake holding pressure needs to increase when the vehicle is heavier (more passengers), or that the brake holding pressure needs to decrease because the braking system is producing noise because of too much pressure.

In some embodiments, ADS 110 may use the following formulas to compute the lower and upper thresholds:

Low holding pressure threshold:P=mg*cos(θ)*u*C*R1+offset1;

High holding pressure threshold:P=mg*cos(θ)*u*C*R2+offset2;

In the above formulas, P is final pressure; m is the weight of vehicle; θ is the gradient of the slope; u is the rate including friction and tire condition; C is a constant for calculating the pressure from force; R1 is the variable for low holding pressure calibration; and R2 is the variable for high holding pressure calibration. In this embodiment, ADS 110 may adjust the constant, R1, and/or R2 as needed in real-time to achieve an accurate brake holding pressure when ADV 101 is stopped on a gradient.

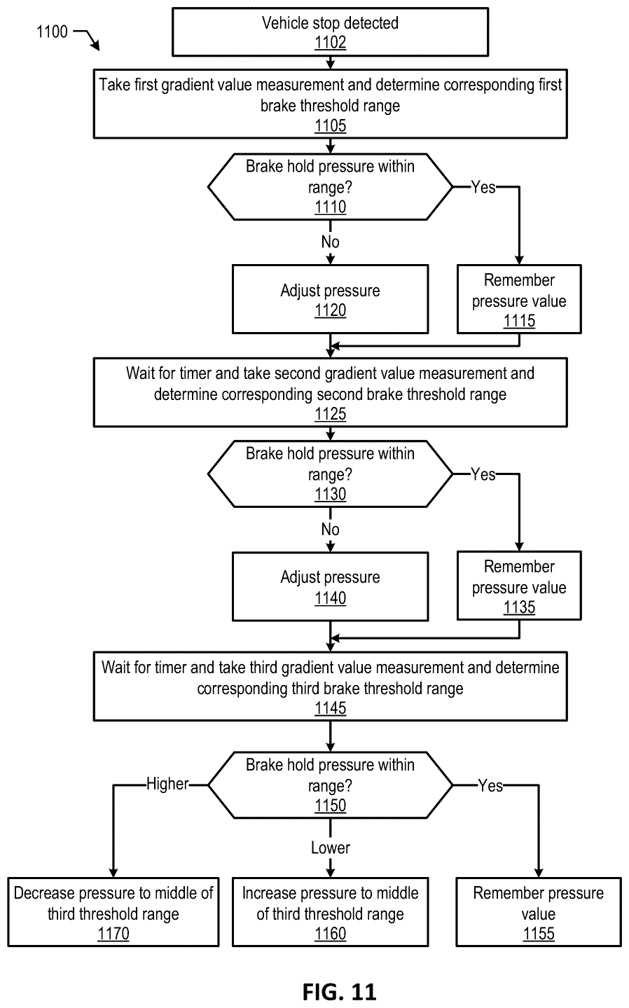

FIG. 11 is a flow diagram illustrating a method to apply an accurate brake holding pressure to ADV 101 according to one embodiment. Process 1100 may be performed by processing logic that may include software, hardware, or a combination thereof. For example, process 1100 may be performed by planning module 305, control module 306, and/or brake intention module 308 of FIG. 3A.

At step 1102, processing logic detects that the ADV has stopped. At step 1105, processing logic takes a first gradient value measurement and determines a corresponding first brake threshold range. As discussed herein, processing logic may use the gradient value and weight of ADV to determine the brake threshold range. Processing logic then determines as to whether the brake hold pressure is within the brake threshold range (decision 1110). If the brake hold pressure is within the brake threshold range, then decision 1110 branches to the ‘yes’ branch whereupon, at step 1115, processing logic remembers the brake hold pressure value (e.g., stores the brake hold pressure value and the corresponding gradient value).

On the other hand, if the brake hold pressure is not within the brake threshold range, then decision 1110 branches to the ‘no’ branch whereupon, at step 1120, processing logic adjusts the pressure accordingly. In a first embodiment, processing logic adjusts the brake hold pressure to the middle of the first brake threshold range by a rate (R1) if more than the upper threshold, and at a rate (R2) if less than the lower threshold. In a second embodiment, processing logic adjusts the brake hold pressure to the middle of the first brake threshold range if the brake hold pressure is under the low threshold.

At step 1125, processing logic takes a second gradient value measurement and determines a corresponding second brake threshold range. Processing logic determines as to whether the current brake hold pressure is within the second brake threshold range (decision 1130). If the brake hold pressure is within the second brake threshold range, then decision 1130 branches to the ‘yes’ branch whereupon, at step 1135, processing logic remembers the brake hold pressure value (e.g., stores the brake hold pressure value and the corresponding gradient value).

On the other hand, if the brake hold pressure is not within the second brake threshold range, then decision 1130 branches to the ‘no’ branch whereupon, at step 1140, processing logic adjusts the brake hold pressure accordingly. In one embodiment, processing logic adjusts the brake hold pressure to the middle of the first brake threshold range at a rate (R4) if less than the lower threshold, and adjusts the brake hold pressure to a value by a rate (R3), or does not perform any ramp down, if more than the upper threshold.

At step 1145, processing logic takes a third gradient value measurement and determines a corresponding third brake threshold range. Processing logic determines as to whether the current brake hold pressure is within the third brake threshold range (decision 1150). If the current brake hold pressure is within the third brake threshold range, then decision 1150 branches to the ‘yes’ branch whereupon, at step 1155, processing logic remembers the brake hold pressure value (e.g., stores the brake hold pressure value and the corresponding gradient value).

On the other hand, if the brake hold pressure is below the third brake threshold range, then decision 1150 branches to the ‘lower’ branch whereupon, at step 1160, the process increases the brake hold pressure to the middle of third brake threshold range. On the other hand, if the brake hold pressure is above the third brake threshold range, then decision 1150 branches to the “higher” branch whereupon, at step 1170, the process decreases the brake hold pressure to the middle of third brake threshold range. In one embodiment, processing logic remembers the adjusted brake hold pressure values from 1160 and 1170 (e.g., stores the brake hold pressure values and the corresponding gradient value).

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A computer-implemented method, comprising:
responsive to determining that that an autonomous driving vehicle (ADV) has stopped on a gradient:
determining a first brake hold pressure based on a first gradient value of the ADV measured at a first point in time;
applying the first brake hold pressure to a brake system in the ADV;
responsive to applying the first brake hold pressure to the brake system, determining a second brake hold pressure based on a second gradient value of the ADV measured at a second point in time; and
applying the second brake hold pressure to the brake system.

2. The method of claim 1, further comprising:
determining a third brake hold pressure based on a third gradient value of the ADV measured at a third point in time; and
applying the third brake hold pressure to the brake system.

3. The method of claim 1, further comprising:
determining a first brake threshold range based on the first gradient value, wherein the first brake hold pressure is based on the first brake threshold range;
determining a second brake threshold range based on the second gradient value;
in response to determining that the first brake hold pressure is within the second brake threshold range; maintaining the second brake hold pressure the same as the first brake hold pressure; and
in response to determining that the first brake hold pressure is outside the second brake threshold range, setting the second brake hold pressure to be within the second brake threshold range.

4. The method of claim 1, wherein the second brake hold pressure is higher than the first brake hold pressure.

5. The method of claim 1, wherein the second brake hold pressure is lower than the first brake hold pressure and reduces an amount of current required to maintain the ADV at a stopped stated on the gradient.

6. The method of claim 1, wherein the ADV generates a processed gradient value for determining the first gradient value and the second gradient value.

7. The method of claim 6, further comprising:
computing, prior to the first point in time, an initial gradient value of the ADV based on a peak value of the processed gradient value and a trough value of the processed gradient value; and
determining the first brake hold pressure based on the initial gradient value.

8. The method of claim 1, wherein the first brake hold pressure and the second brake hold pressure are based on a weight of the ADV.

9. The method of claim 1, wherein the gradient is a descending gradient.

10. A non-transitory machine-readable medium having instructions stored therein, which when executed by a processor, cause the processor to perform operations, the operations comprising:
responsive to determining that that an autonomous driving vehicle (ADV) has stopped on a gradient:
determining a first brake hold pressure based on a first gradient value of the ADV measured at a first point in time;
applying the first brake hold pressure to a brake system in the ADV;
responsive to applying the first brake hold pressure to the brake system, determining a second brake hold pressure based on a second gradient value of the ADV measured at a second point in time; and
applying the second brake hold pressure to the brake system.

11. The non-transitory machine-readable medium of claim 10, wherein the operations further comprise:
determining a third brake hold pressure based on a third gradient value of the ADV measured at a third point in time; and
applying the third brake hold pressure to the brake system.

12. The non-transitory machine-readable medium of claim 10, wherein the operations further comprise:
determining a first brake threshold range based on the first gradient value, wherein the first brake hold pressure is based on the first brake threshold range;
determining a second brake threshold range based on the second gradient value;
in response to determining that the first brake hold pressure is within the second brake threshold range; keeping the second brake hold pressure the same as the first brake hold pressure; and
in response to determining that the first brake hold pressure is outside the second brake threshold range, setting the second brake hold pressure to be within the second brake threshold range.

13. The non-transitory machine-readable medium of claim 10, wherein the second brake hold pressure is higher than the first brake hold pressure.

14. The non-transitory machine-readable medium of claim 10, wherein the second brake hold pressure is lower than the first brake hold pressure and reduces an amount of current required to maintain the ADV at a stopped stated on the gradient.

15. The non-transitory machine-readable medium of claim 10, wherein the ADV generates a processed gradient value for determining the first gradient value and the second gradient value.

16. The non-transitory machine-readable medium of claim 15, wherein the operations further comprise:
computing, prior to the first point in time, an initial gradient value of the ADV based on a peak value of the processed gradient value and a trough value of the processed gradient value; and
determining the first brake hold pressure based on the initial gradient value.

17. The non-transitory machine-readable medium of claim 10, wherein the first brake hold pressure and the second brake hold pressure are based on a weight of the ADV.

18. The non-transitory machine-readable medium of claim 10, wherein the gradient is a descending gradient.

19. A system comprising:
a processing device; and
a memory to store instructions that, when executed by the processing device cause the processing device to:
determine that that an autonomous driving vehicle (ADV) has stopped on a gradient;
determine a first brake hold pressure based on a first gradient value of the ADV measured at a first point in time;
apply the first brake hold pressure to a brake system in the ADV;
responsive to applying the first brake hold pressure to the brake system, determine a second brake hold pressure based on a second gradient value of the ADV measured at a second point in time; and
apply the second brake hold pressure to the brake system.

20. The system of claim 19, further comprising:
a processed gradient value for determining the first gradient value and the second gradient value; and
wherein the processing device, responsive to executing the instructions, further causes the system to:
compute, prior to the first point in time, an initial gradient value of the ADV based on a peak value of the processed gradient value and a trough value of the processed gradient value; and
determine the first brake hold pressure based on the initial gradient value.
